(19) United States
(12) Patent Application Publication
(10) Pub. No.: US 2004/0174851 A1
(43) Pub. Date: Sep. 9, 2004

(54) Dual purpose power line modem

(76) Inventors: Yeshayahu Zalitzky, Raanana (IL); Ofir Efrati, Raanana (IL)

Correspondence Address: William H Dippert, Reed Smith, 599 Lexington Avenue, 29th Floor, New York, NY, 10022-7650, US

(21) Appl. No.: 10/484,282

(22) PCT Filed: Jul. 17, 2002
(86) PCT No.: PCT/IL02/00582

Related U.S. Application Data
(60) Provisional application No. 60/306,030, filed on Jul. 17, 2001.
(60) Provisional application No. 60/307,251, filed on Jul. 23, 2001.

(30) Foreign Application Priority Data
Aug. 12, 2001 (WO) PCT/IL01/00745

(51) Int. Cl. H04Q 7/24

(52) U.S. Cl. 370/338; 375/222

(57) ABSTRACT

A modem which includes an application interface for receiving packets to be transmitted on an electrical power network, a network interface connecting the modem to the electric power network, at least one media access control (MAC) unit adapted to perform MAC layer tasks in accordance with at least two different MAC protocols, on packets received from the application interface, and at least one physical layer unit adapted to transmit packets from the at least one MAC unit onto the electric power network, through the network interface, in a same frequency band.

### RELATED APPLICATIONS

This application claims the benefit under 119 (e) of U.S. provisional patent applications 60/306,030, filed Jul. 17, 2001, and 60/307,251, filed Jul. 23, 2001, the disclosures of which documents are incorporated herein by reference. The present application is also a continuation-in-part (CIP) of PCT application WO 02/15413, filed Aug. 12, 2001, the disclosure of which is incorporated herein by reference.

### FIELD OF THE INVENTION

The present invention relates to signal transmission over power lines.

### BACKGROUND OF THE INVENTION

It is known in the art to transmit data signals between a plurality of devices within a close vicinity through electric power lines. For example, the medium interface specification, version 1.0, of the HomePlug powerline alliance, the disclosure of which is incorporated herein by reference, describes methods of communicating over electric power lines. It is noted, however, that these methods are limited in their range due to the high noise levels of electric power lines, and therefore are generally used only for short distance communication, e.g., in house use.

It is also known to use electric power lines for access to external communication networks, such as the Internet. For example, EP patent publication 0,975,097, the disclosure of which is incorporated herein by reference, describes a method of exchanging data between a customer and a service provider over low and medium voltage AC electric power networks. The data is exchanged using a COFDM transmission method.

A device for connecting to both other devices in the same vicinity and to an external access unit, requires two different modems, which operate in accordance with the two different transmission methods. In addition, the different modems must use different frequency bands or on different communication lines in order not to interfere with each other.

Due to the fast rate of change in the quality of electrical power lines, the HomePlug transmission method suggests a periodic quality estimation method. In the quality estimation method, a source modem transmits a quality estimation request to a destination modem. The destination modem evaluates the channel from the source to the destination according to the received request. Accordingly, the destination modem selects a tone map in which it is to receive signals and notifies the source modem which tone map is to be used. This estimation method uses a relatively small amount of information, i.e., the information included in a single message. Transmitting a longer estimation request packet or transmitting a plurality of packets would add to the delay of the system and reduce its throughput.

### SUMMARY OF THE INVENTION

An aspect of some embodiments of the present invention relates to a single modem adapted to communicate in accordance with a plurality of different media access control (MAC) transmission methods. In an exemplary embodiment of the invention, one of the MAC protocols is used for short range (e.g., in house) communication, and a second MAC method is used for longer range (e.g., outdoor) communication, for example to a local access unit. In some embodiments of the invention, a first one of the MAC methods is a standard MAC method known in the art and a second MAC method is a revised version of the first method adapted for longer range transmission.

In some embodiments of the invention, the MAC methods differ in the length of the control packets they use. Alternatively or additionally, the MAC methods differ in whether they include an ending delimiter. Further alternatively or additionally, the MAC methods differ in the timing periods defined for transmitting signals on the transmission lines used, for example in the times defined for transmitting response signals. In some embodiments of the invention, the MAC methods differ in whether they allow for using an intermediate modem as a repeater between two modems connected to the same network.

In an exemplary embodiment of the invention, the plurality of MAC methods comprise a first method in which a device begins to transmit data without requesting to transmit beforehand (although possibly after verifying that the transmission medium is clear for transmission). Such first method may be in accordance with the Ethernet protocol and/or the HomePlug method. Optionally, the plurality of MAC methods include a second method in which a device transmits a request to transmit and waits for a clearance-to-transmit massage before transmitting data (e.g., in accordance with a carrier sense multiple access collision avoidance (CSMA/CA) method).

Optionally, the modem uses one or more common physical layer transmission methods for packets in accordance with the different MAC methods. The plurality of different MAC methods optionally generate packets having at least one common attribute, such that modems adapted to operate in accordance with only one of the MAC methods can decipher at least one portion of packets generated in accordance with other MAC methods.

In some embodiments of the invention, the modem transmits packets in accordance with the plurality of different MAC methods on a single network link, optionally an electrical power line. In some embodiments of the invention, the packets of the different MAC methods are transmitted in the same frequency band.

In some embodiments of the invention, the modem includes a single physical layer unit. Optionally, in these embodiments, the same physical layer capabilities are required for the different MAC methods. Alternatively, the physical layer unit has enhanced capabilities beyond those required for at least one of the MAC methods, so as to operate with the plurality of MAC methods. Further alternatively or additionally, the modem includes a plurality of different physical layer units, optionally having a separate physical layer unit for each MAC method.

An aspect of some embodiments of the invention relates to transmitting signals in accordance with a plurality of different MAC methods on a single link, in a common frequency band.

An aspect of some embodiments of the invention relates to transmitting a message from a source to a destination, connected to a common electrical power communication link, through one or more intermediate devices also connected to the same link. Optionally, the message is transmitted through the one or more intermediate devices due to a determination that the range between the source and destination is longer than allows a sufficient transmission quality. Alternatively or additionally, the message is transmitted through the one or more intermediate devices due to incompatibility of the MAC methods used by the source and destination. For example, the source and destination modems may use first and second MAC methods, respectively, while an intermediate modem is adapted to use both MAC methods.

In some embodiments of the invention, more than one intermediate device may be used between the source and destination. For example, one or more intermediate devices may be used to overcome distance problems, while one or more intermediate devices are used for interpretation between different MAC methods. In some embodiments of the invention, the source modem does not necessarily know all the intermediate modems to be used for transmitting to the destination. The source modem optionally transmits the packet to a first intermediate modem, which in turn forwards the packet to a second intermediate modem.

The intermediate device to be used is optionally determined by the source from listening to packets transmitted on the power lines. The packets from which the intermediate device is determined are optionally not related to the determination of the intermediate device to be used. The determination of the intermediate device to be used is optionally performed based on data packets, acknowledgment packets and/or request to transmit packets. These packets are optionally transmitted at the initiative of a device other than the device selecting the intermediate device.

Alternatively or additionally, the source device transmits a query requesting to know which devices can contact the destination. Optionally, at least some of the packets transmitted on the power lines carry addresses in their delimiters, which are understandable by all the devices connected to the power lines. Thus, the addresses of the packets passing on the power lines are open for review by intermediate devices, which can use them for routing determination and/or channel estimation.

In some embodiments of the invention, the determination of whether to perform direct transmission or through one or more intermediate modems is performed based on a comparison of expected throughput and/or delay. For example, direct transmission may require use of a slow transmission rate, while using an intermediate modem incurs extra delay. The better option is preferably chosen.

An aspect of some embodiments of the invention relates to estimating the quality of a channel from a first modem to a second modem, at least partially based on signals transmitted from the first modem to a third modem. The first, second and third modems are all connected through a link in which all devices can hear each other, depending on the channel quality. The second modem optionally selects one or more parameters of signals it is to receive from the first modem based on the quality, as perceived by the second modem, of signals transmitted by the first modem to the third modem. Optionally, the selection of the one or more parameters is determined based on estimation performed on a plurality of signals received by the second modem. Alternatively or additionally, the second modem notifies the first modem on quality estimation results of at least some of the signals the second modem receives from the first modem and the first modem selects the one or more parameters used in transmission.

In some embodiments of the invention, the channel estimation is performed based on channel estimation requests. Alternatively or additionally, the channel estimation is performed based on data signals and/or other control signals.

There is therefore provided in accordance with an embodiment of the present invention, a modem, comprising an application interface for receiving packets to be transmitted on an electrical power network, a network interface connecting the modem to the electric power network, at least one media access control (MAC) unit adapted to perform MAC layer tasks in accordance with at least two different MAC protocols, on packets received from the application interface, and at least one physical layer unit adapted to transmit packets from the at least one MAC unit onto the electric power network, through the network interface, in a same frequency band.

Optionally, the at least one physical layer unit comprise a single physical layer unit.

Optionally, the at least one physical layer units comprise a plurality of physical layer units. Optionally, the plurality of physical layer units use different modulation methods. Optionally, the plurality of physical layer units use different sets of carriers to carry packets. Optionally, each of the physical layer units is adapted to transmit packets in accordance with a different respective MAC method. Optionally, the at least one physical layer unit is adapted to transmit each packet at an output power level which depends on the MAC protocol used for transmitting the packet.

Optionally, the physical layer comprises an analog amplifier adapted to apply different amplification levels to packets transmitted, according to the MAC protocols used for transmitting the packets. Alternatively or additionally, the physical layer is adapted to adjust the power level of digital signals of packets received from the at least one MAC unit, before they are converted into analog signals, according to the MAC protocols used for transmitting the packets.

Optionally, the at least one physical layer unit is adapted to transmit packets of the plurality of different MAC protocols in a same frequency band. Alternatively or additionally, the at least one physical layer unit is adapted to transmit packets of the plurality of different MAC protocols in different respective frequency bands.

Optionally, the packets of at least one of the MAC protocols include at least one address field in a header which is understandable by substantially all the devices connected to the network. Optionally, at least one of the MAC protocols allows for retransmission of packets on the same network as on which they were received. Alternatively or additionally, the plurality of MAC protocols differ in the length of the MAC additions to at least some of the packets they handle. Alternatively or additionally, the plurality of MAC protocols differ in their ability to use an intermediate modem as a repeater. Optionally, the packets of the plurality of MAC protocols have at least one field having a common format.

There is further provided in accordance with an embodiment of the present invention, a method of utilizing an electric power network, comprising transmitting a plurality of packets in accordance with a first MAC protocol on the power network, and transmitting at least one packet in accordance with a second MAC protocol on the power network, in a same frequency range as the packet of the first MAC protocol, between the plurality of packets of the first protocol.

Optionally, the first and second MAC protocols differ in the times waited when the network is busy. Alternatively or additionally, the first and second MAC protocols differ in the number of delimiters included in data packets transmitted in accordance with the protocols.

Optionally, the first and second MAC protocols differ in the transmission distances they achieve.

There is further provided in accordance with an embodiment of the present invention, a method of transmitting a packet between a source and a destination connected with one or more intermediate devices to a common power line, comprising transmitting the packet from the source to a first intermediate device, on the common electric power link, and transmitting the packet from the first intermediate device on to the common electric power link.

Optionally, transmitting the packet from the first intermediate device comprises transmitting according to a MAC protocol different from that used in transmitting from the source. Optionally, transmitting the packet from the first intermediate device comprises transmitting according to a same MAC protocol as that used in transmitting from the source.

Optionally, transmitting the packet from the source comprises transmitting with a power level not sufficient for reception of the packet by the destination. Optionally, transmitting the packet from the source to the first intermediate device comprises transmitting to an intermediate device selected by the source based on the contents of one or more packets not solicited by the source, which were transmitted on the electric power link.

Optionally, transmitting the packet from the source to the first intermediate device comprises transmitting to an intermediate device selected by the source based on the contents of one or more packets transmitted by the intermediate device to another device, different from the source.

In some embodiments of the invention, the packet is transmitted by the intermediate device immediately upon its reception and/or without storing the packet in the intermediate device. Optionally, the intermediate device operates as a regular device in the network and is not dedicated for serving as an intermediate device. In some embodiments of the invention, some or all of the devices connected to the common power line serve as source and destination devices as well as intermediate devices.

There is further provided in accordance with an embodiment of the present invention, a method of selecting one or more parameters for transmission of signals from a first device to a second device, comprising receiving, by the second device, at least one packet not directed to the second device, estimating the channel quality responsive to the received at least one packet, and selecting the one or more parameters at least partially based on the estimating of the channel.

Optionally the method includes storing by the second device, for one or more other devices, results of estimation of the channel quality. Optionally, receiving the at least one packet comprises receiving a plurality of packets. Optionally, receiving the at least one packet comprises receiving packets transmitted by the first device.

There is further provided in accordance with an embodiment of the present invention, a method of selecting one or more parameters for transmission of signals from a first device to a second device on a multi-device link, comprising receiving, by the second device, a plurality of packets from the first device, estimating the channel quality responsive to the received packets, and selecting the one or more parameters at least partially based on the estimating of the channel quality.

Optionally, receiving the plurality of packets comprises receiving at least one packet not transmitted to the first device.

Optionally, receiving the plurality of packets comprises receiving at least one packet stating a source address in a header which is understandable by all the devices connected to the multi-device link. Optionally, the multi-device link comprises an electrical power link.

### BRIEF DESCRIPTION OF FIGURES

Particular exemplary embodiments of the invention will be described with reference to the following description of embodiments in conjunction with the figures, wherein identical structures, elements or parts which appear in more than one figure are preferably labeled with a same or similar number in all the figures in which they appear, in which:

FIG. 1 is a schematic block diagram of a transmission system utilizing electric power lines, in accordance with an embodiment of the present invention;

FIGS. 2A, 2B, 3A and 3B are schematic illustrations of formats of packets transmitted on electric power lines, in accordance with exemplary embodiments of the present invention;

FIG. 4 is a schematic block diagram of a dual purpose modem, in accordance with an exemplary embodiment of the present invention;

FIG. 5 is a flowchart of acts performed by a modem in handling a packet provided by a computer for transmission, in accordance with an embodiment of the present invention; and

FIG. 6 is a flowchart of acts performed in receiving a packet, in accordance with an embodiment of the present invention.

### DETAILED DESCRIPTION OF EMBODIMENTS

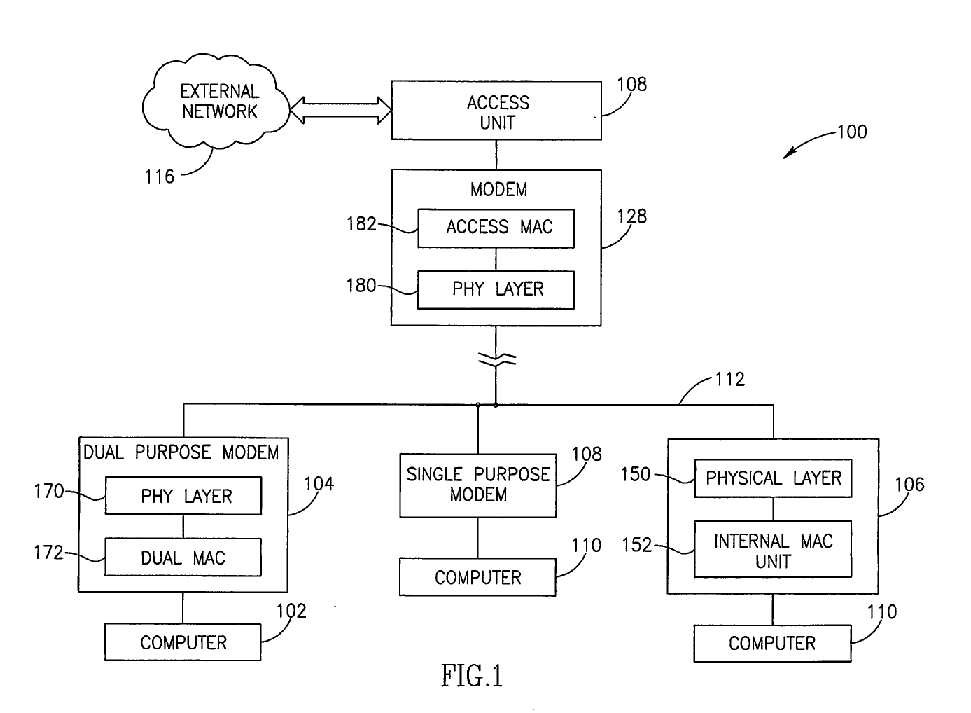

FIG. 1 is a schematic block diagram of a transmission system 100 utilizing electric power lines 112, in accordance with an embodiment of the present invention. A computer 102 is connected through a dual purpose modem 104 to power lines 112, which lead to one or more other computers 110 within system 100 and to an access unit 108, which serves as a gateway to an external network 116. External network 116 may be a data network, such as the Internet, a switched network, such as a telephone network. In some embodiments of the invention, external network 116 uses electrical power lines for carrying data. Alternatively, external network 116 uses any other communication medium, such as optical fibers and/or cable wires. Although only one access unit 108 is shown, more than one access unit 108 to same or different external networks, may be included in system 100. Access unit 108 includes a modem 128, which may be a stand alone modem or may be included in a modem array, such as a remote access server (RAS).

In some embodiments of the invention, power lines 112 serve as a multi-device link, allowing to connect three or more devices to each other. Generally in multi-device links, all the devices connected to the multi-device link can hear the signals transmitted by all the other devices. It is noted, however, that on power lines 112, due to the high noise levels, some devices may not receive the signals from all the other devices.

In some embodiments of the invention, access unit 108 is distanced from computer 102 by a distance longer than the distance between computers 102 and 110. In an exemplary embodiment of the invention, the distance between computers 102 and 110 is up to about 50-100 meters, while the distance between computer 102 and access unit 108 is up to about 500-1000 meters. In some embodiments of the invention, computers 102 and 110 are located within a single building, while access unit 108 is remote from the building, for example in a central office servicing the building. In some embodiments of the invention, access unit 108 translates signals received in a first format into signals of a totally different format.

Optionally, other computers 110 are connected to power lines 112, through single purpose modems 106, which are used only for communication within system 100. Alternatively, one or more of other computers 110 are connected to power lines 112 through dual purpose modems 104, such as shown as being connected to computer 102, allowing communication between these other computers and external networks. Further alternatively or additionally, one or more of other computers 110 are connected to power lines 112 through a modem suitable for connection only to access unit 108.

In some embodiments of the invention, single purpose modems 106 comprise a physical layer unit 150, such as an orthogonal frequency division multiplexing (OFDM) unit, and an internal media access control (MAC) unit 152, which operates, for example, in accordance with 802.3 methods, such as a HomePlug MAC unit. For clarity, the inner structure of modem 106 is shown in only one instance in FIG. 1, the other instances generally have the same structure. In an exemplary embodiment of the invention, single purpose modems 106 comprise modems known in the art, which do not require any alterations.

Modem 128 of access unit 108 optionally comprises a physical layer unit 180 and an access MAC unit 182, which operates, for example, in accordance with a CSMA/CA method, optionally using provisions similar to those of the 802.11 protocol. In an exemplary embodiment of the invention, access MAC unit 182 operates according to the methods described in the above mentioned PCT publication WO 02/15413.

The MAC layer, referred to also as layer 2, generally governs the transmission of packets (referred to also as frames) between units connected to a same data link. The MAC layer, for example, is in charge of preventing collisions, selecting signal formats and/or transmission rates to be used and directing packets to specific devices connected to the same link.

In some embodiments of the invention, access MAC unit 182 operates in accordance with a MAC method which is an enhanced version of the MAC method of internal MAC unit 152. The MAC method of access unit 182 optionally includes addresses in the delimiters of at least some of the transmitted packets, such that the addresses can be determined by third party modems along power lines 112. Alternatively or additionally, the MAC method of access unit 182 allows for transmitting packets through one or more intermediate modems, as described hereinbelow.

Dual purpose modem 104 optionally comprises a physical layer unit 170 and a dual MAC unit 172, which is adapted to communicate in accordance with both the MAC protocol of access MAC unit 182 and the MAC protocol of internal MAC unit 152.

The use of different MAC methods for communicating with other computers 110 and for communication with access unit 108, allows optimizing the transmission method used, for the specific transmission destination. In some embodiments of the invention, the MAC method used for communicating with access unit 108 is optimized to achieve longer distance transmission, while the MAC method used for communicating with other computers 110 is optimized to achieve faster transmission.

In addition, the use of two different MAC methods by dual purpose modem 104, allows interoperability of the modem with widely available modems, for example for communication between computers, while using a new MAC method with enhanced abilities, for example for communicating with access unit 108. Although different MAC methods are used in system 100 for internal and access communication, in some embodiments of the invention, the same physical layer provisions are used, such that physical layers 150, 170 and 180 are similar. This allows dual purpose modem 104 to include a single physical layer unit 170 both for communicating with other computers and for communicating with access unit 108. Thus, the cost of dual purpose modem 104 is substantially reduced.

The packets transmitted in accordance with the access and internal MAC methods optionally have a common general structure, such that modems 106 recognize access packets and/or access unit 108 recognizes internal packets. The recognizing of the packets allows modem 106 and unit 108 to better avoid collisions between access and internal packets.

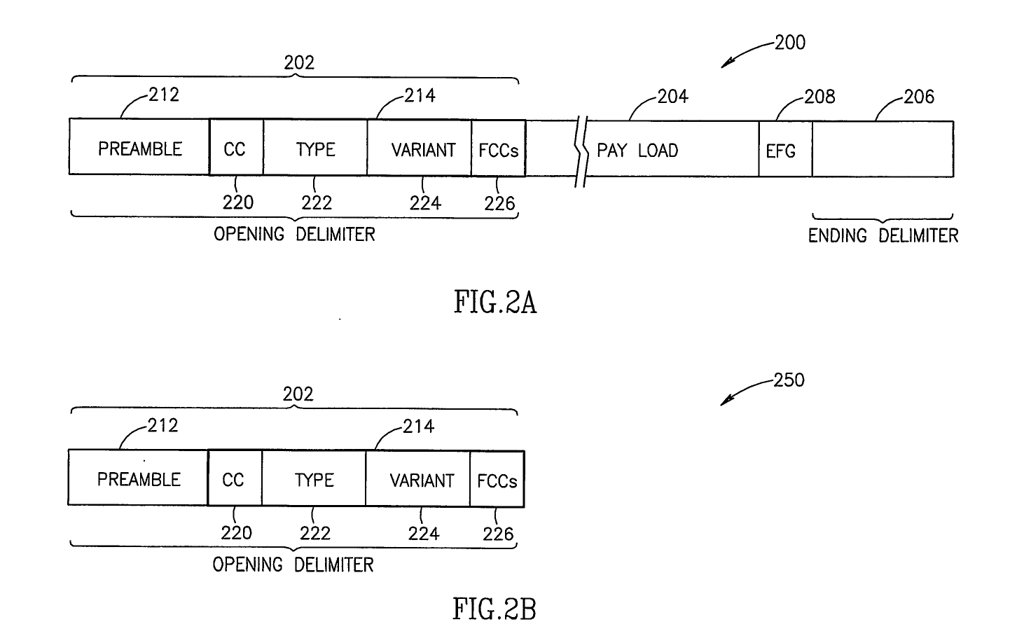

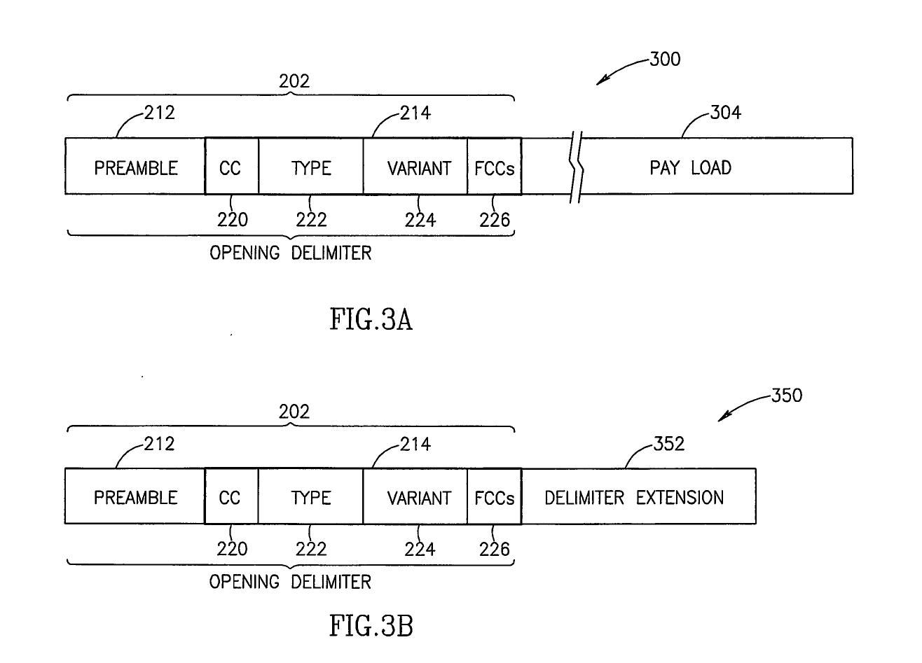

In an exemplary embodiment of the invention, internal packets used by internal MAC methods may be either long internal packets as described with reference to FIG. 2A or short internal packets as described with reference to FIG. 2B. Access packets are optionally either long access packets as described with reference to FIG. 3A or short access packets as described with reference to FIG. 3B.

FIG. 2A is a schematic illustration of a long internal packet 200, in accordance with an exemplary embodiment of the present invention. In the exemplary embodiment of FIG. 2A, packet 200 is in accordance with the HomePlug standard. Long internal packet 200 optionally includes an opening delimiter 202, a payload 204 and an ending delimiter 206. Ending delimiter 206 is separated from payload 204 by an end of frame gap (EFG) 208.

FIG. 2B is a schematic illustration of a short internal packet 250, in accordance with an exemplary embodiment of the present invention. In the exemplary embodiment of FIG. 2B, packet 250 is in accordance with the HomePlug standard. Short internal packet 250 includes only an opening delimiter 202 and is generally used for reception acknowledgment.

In accordance with the HomePlug standard, delimiters 202 and 206 comprise a preamble 212, and a frame control field 214. Preamble 212 includes a constant set of symbols which may be used for various physical tasks, such as gain control. Frame control field 214 comprises 25 bits according to the following distribution:

1 bit—contention control (CC) 220,

3 bits—delimiter type 222,

13 bits—variant field 224, and

8 bits—frame control check sequence (FCCS) 226, which serves as a CRC of the frame control field.

Delimiter type 222 indicates whether the control frame belongs to the beginning or end of a packet, whether the packet requires a response or whether the packet is a response packet. For frame control fields 214 at the beginning of a packet, variant field 224 indicates the length of the packet and the tone map index used in transmitting the payload 204 of the packet. While this protocol is described in some detail, the invention is not limited to the use of this protocol for internal communication. Other suitable protocols may be used.

FIG. 3A is a schematic illustration of a long access packet 300, in accordance with an exemplary embodiment of the present invention. Long access packets optionally include an opening delimiter 202, substantially as in internal transmission packets 200 and a payload 304, but do not include an ending delimiter 206. The end delimiter adds to the length of the packets and therefore reduces the throughput of power lines 112, substantially without adding information.

Payload 304 in access packets 300 optionally includes a field (not shown separately) for indicating a final destination modem. When an access packet is received by a modem, the modem optionally determines the final destination and if the receiving modem is not the final destination forwards the packet towards the final destination, on the same power lines 112 from which the packet was received. The transmission of the packet optionally includes changing the MAC method used for the packet. In some embodiments of the invention, payload 304 of access packets 300 additionally includes an original source field, a current source field and/or a current destination field (not shown in detail).

FIG. 3B is a schematic illustration of a short access packet 350, in accordance with an exemplary embodiment of the present invention. Short access packet 350 optionally includes an opening delimiter 202 and a delimiter extension 352. In some embodiments of the invention, one or more fields of opening delimiter 202 of access packets 300 and 350 comprise a value which identifies the packet as an access packet and not an internal packet. Optionally, the delimiter type 222 of access packets has a unique value that identifies the packet as an access packet. Short access packets 350 are optionally used for control purposes, for example as request-to-send (RTS) packets and/or clear-to-send (CTS) packets, described in the above mentioned PCT publication WO 02/15413.

In some embodiments of the invention, one or more portions of frame control field 214 of access packets 300 and 350 has a value which causes single purpose modems 106 to refrain from transmitting packets on power lines 112 for a period required for the transmission according to the MAC access protocol. Optionally, the delimiter type 222 value serves for this purpose by having a value not defined for internal MAC transmissions. Alternatively or additionally, the packet length stated by variant field 224 is a very long length, optionally one not supported by the internal MAC protocol. Further alternatively or additionally, the value of FCCS 226 is indicative of whether the packet is an internal packet or an access packet. For example, an incorrect FCCS value, according to the internal MAC protocol, may be used to causes single purpose modems 106 to refrain from transmitting packets on power lines 112 for a period required for the transmission according to the MAC access protocol.

Similarly, in some embodiments of the invention, one or more portions of frame control field 214 of internal packets 200 and 250 (FIGS. 2A and 2B) has a value which causes access unit 108 to refrain from transmitting packets on power lines 112 for a period required for the transmission according to the internal MAC protocol.

Delimiter extension 352 optionally states the source and destination modems of the packet, such that any of the modems receiving the packet can use the packet to determine channel and/or routing parameters. It is noted that the payload of packets 200 and 300 may be encoded and/or may be in accordance with a tone map not available to modems other than the source and destination modems, such that its contents may not be used in some cases for parameter determination.

The use of a common delimiter format for access packets 300 and 350 and internal transmission packets 200 and 250, allows all the modems connected to power lines 112 to understand at least a header of the signals transmitted on the lines, even if they support only one of the MAC protocols. This allows better collision prevention, as all the modems 104 and 106 are aware that the transmitted signals are not noise and will not attempt to transmit on signals of the other MAC protocol. It is noted, however, that in some embodiments of the invention, the payloads of the access and internal packets may have totally different formats and/or structures, such that modems 106 may not be able to decipher the contents of the payload of access packets 300.

In an exemplary embodiment of the invention, frame control field 214 of access packets uses the CC field 220 to state whether the packet includes a delimiter extension, as this bit is not required for contention control in the access MAC protocol. Alternatively, any other available bit of the frame control field 214 may be used for indication of the extended delimiter field, such as one of the bits of delimiter type 222 (e.g., a value of 110 for access packets without an extended delimiter and a value of 111 for access packets with an extended delimiter).

In some embodiments of the invention, FCCS 226 of short access packets 350 having a delimiter extension 352 has a value determined also based on the bits of the delimiter extension, so as not to add extra bits for correctness verification. Alternatively, delimiter extension 352 has a separate redundancy check field, so as to allow modems 106 to check the validity of frame control field 214, although they do not support the access MAC protocol.

In some embodiments of the invention, the number of bits used for indicating the tone map used in an access packet 300 or 350 is the same as in internal packets 200. Alternatively, additional bits are provided in access packets for indicating the tone map to be used, so as to enhance the number of possible tone maps. For example, internal packets may use 5 bits to indicate tone maps, allowing up to 32 possible tone maps, access packets may use 8 bits, allowing up to 256 possible tone maps.

Alternatively to using an extended delimiter 352 in short access packets 350, packets of the same external format as short internal packets 250 are used as short access packets. Instead of the field division described above, however, the 25 bits of the frame control field are used to state the source and destination addresses. Optionally, addresses of 7-8 bits are used. In some embodiments of the invention, the addresses are configured manually by a system operator or are determined automatically using any address assignment method known in the art. Optionally, a shorter FCCS field is used, for example only 4-5 bits.

Optionally, in this alternative, when a packet is received, the FCCS field is checked to determine whether the packet is an access packet or whether the packet is an internal packet. If the FCCS check of 8 bits of packet 250 is successful, the packet is considered an internal packet. In some embodiments of the invention, if the FCCS check is not successful, the receiving modem determines whether the FCCS field includes the complimentary of the correct FCCS in the shortened FCCS field. If the check is successful, the packet is considered an access packet. Otherwise, the packet is optionally considered erroneous and is discarded. By using the complimentary of the FCCS value for access packets, packets will not be mistakenly taken as internal packets due to a chance.

When an internal packet is transmitted on power lines 112, access unit 108 optionally identifies that the packet is an internal packet and refrains from transmitting packets for a predetermined time, in order to avoid collisions. In some embodiments of the invention, access unit 108 is adapted to differentiate between different types of internal packets in order to better estimate when power lines 112 will be idle (i.e., not in use). Optionally, access unit 108 differentiates between long and short internal packets and/or between packets requiring acknowledgment and those not requiring acknowledgment. In some embodiments of the invention, access unit 108 differentiates between the different packets based on the contents of frame control field 214 of the received packets.

Similarly, when an access packet is transmitted on power lines 112, modems 106 optionally identify that the packet is an access packet (or otherwise a non-internal packet) and refrain from transmitting packets for a predetermined time, in order to avoid collisions.

When computer 102 (FIG. 1) provides a packet to modem 104 for transmission, modem 104 determines whether the packet is directed internally to another computer 110, or externally to access unit 108. The determination is optionally performed according to the process from which the packet is received and/or according to the Ethernet and/or IP address of the destination of the packet. According to the destination of the packet, dual MAC unit 172 performs the required MAC operations and transmits the packet on power lines 112. When dual modem 104 receives a packet from power lines 112 it determines according to which MAC the packet was generated and accordingly handles the packet and forwards the packet to an application layer on computer 102.

In some embodiments of the invention, the same channel quality estimation methods are used for both MAC methods. That is, channel quality estimation results received using one of the MAC protocols are used for the other protocol. Alternatively, different channel estimation methods are used for the different MAC methods. In some embodiments of the invention, channel estimation packets of one MAC type are ignored by modems of the other MAC type. Alternatively, modems of one type do not respond to channel estimation request packets of the other type, but use the information in the packets to update their tone map tables, if they understand the packets.

In dual purpose modem 104, the results of the different channel estimation methods are optionally used for generating different tone map tables for the internal and access packets. The use of different tables limits the number of updates performed due to changes between the different MAC methods. Alternatively, the results of the different channel estimation methods are used in generating a single tone map table.

In some embodiments of the invention, dual purpose modem 104 is implemented by a processor which runs separate tasks for the different MAC protocols. Alternatively, the same task, with different attributes, performs the different MAC methods. Further alternatively or additionally, dual purpose modem 104 includes two different hardware units, each hardware unit for one of the MAC methods. The hardware units may comprise processors and/or dedicated hardware units, such as ASICs.

In some embodiments of the invention, physical 150 is a standard unit known in the art. Physical layer unit 170 is optionally similar to physical layer 150 but includes one or more additional features. Optionally, physical layer unit 170 is adapted to transmit the delimiter extension of short access packets 350. Alternatively or additionally, physical layer unit 170 is adapted to use a larger number of tone maps than is customary for internal MAC methods. For example, if physical layer unit 150 is adapted to use up to 32 different tone maps, physical layer unit 170 may be adapted to use up to 256 tone maps.

Optionally, the frequencies on which a packet is transmitted by physical layer unit 170 are controllable by dual MAC unit 172, for example using methods known in the art. This may be used, for example, when different frequency ranges are used for access packets and for internal packets.

In some embodiments of the invention, physical layer unit 170 of dual purpose modem 104 has a controllable transmission power level. Optionally, the transmission power of physical layer unit 170 has a level for access transmission and a level for internal transmission. Generally, a higher power level is preferable for transmission to access unit 108 which is generally farther from computer 102 than other computers 110. In some embodiments of the invention, the transmission power level is controlled by changing the digital signal provided to an analog front-end of physical layer unit 170. Alternatively or additionally, the transmission power level is controlled by an analog amplifier connecting physical layer 170 to power lines 112.

Alternatively to dual purpose modem 104 having a single physical layer unit 170, dual purpose modem 104 comprises two separate physical layer units for the different MAC methods. In some embodiments of the invention, the two separate physical layer units differ in the modulation methods they use. Optionally, the two separate physical layer units use different carrier sets, for example, carriers having different spacings and/or different widths.

The use of two separate physical layer units, allows using standard physical layers, such as in modem 106 and access unit 108, rather than using a controllable physical layer unit.

In some embodiments of the invention, dual purpose modem 104 may be configured to operate in either of an access MAC mode or an internal MAC mode. Optionally, in these embodiments, dual purpose modem 104 does not operate in accordance with both MAC modes at the same time. In some embodiments of the invention, a user of computer 102 instructs modem 104 in which mode to operate at any time, for example using a software directive and/or a switch on modem 104. Alternatively or additionally, dual purpose modem 104 may be configured to operate in both the access MAC mode and the internal MAC mode substantially concurrently.

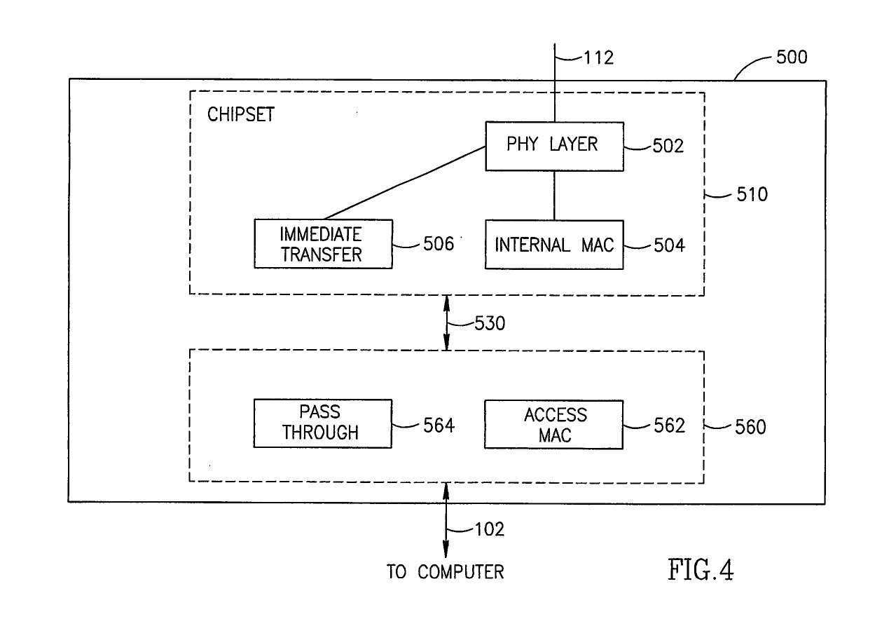

FIG. 4 is a schematic block diagram of a dual purpose modem 500, in accordance with an exemplary embodiment of the present invention. Modem 500 is optionally used instead of modem 104, in some embodiments of the invention. Modem 500 comprises a chipset 510 similar in structure to single purpose modems 106, i.e., including a physical layer unit 502 and an internal MAC unit 504. Chipset 510 optionally additionally includes an immediate transfer unit 506, which allows use of physical layer 502, with MAC units other than that of internal MAC unit 504. Dual purpose modem 500 optionally further includes an add-on MAC unit 560, for communication with external access units 108. Add-on MAC unit 560 optionally includes an access MAC unit 562 and a pass through unit 564 for transferring messages to and from internal MAC unit 504. Add-on MAC unit 560 optionally connects to chipset 510 through an internal data link 530, optionally using a media independent interface (MII). Optionally, the MII interface operates in a half duplex mode.

By forming dual purpose modem 500 from a chipset 510 similar to single purpose modems 106 known in the art, together with an add-on MAC unit 560, the cost of dual purpose modem 500 is substantially reduced, because the cost of planning chipset 510 is relatively low, due to its similarity to existing modems.

In some embodiments of the invention, add-on MAC unit 560 operates as a master of chipset 510, controlling the operation mode thereof e.g., whether internal MAC unit 504 and/or immediate transfer unit 506 are operative.

In some embodiments of the invention, control signals are exchanged between add-on MAC unit 560 and chipset 510 on internal data link 530, together with the data transmitted by the modem. Optionally, the control signals are included in separate packets of a special format. Alternatively or additionally, the control signals exchanged between add-on MAC unit 560 and chipset 510 are appended to data packets passing on link 530. For example, add-on MAC unit 560 may append control signals to packets provided to chipset 510 for transmission on power lines 112. Optionally, chipset 510 removes the control signals from the packets before transferring the signals for transmission on power lines 112. Further alternatively or additionally, the control signals are exchanged between add-on MAC unit 560 and chipset 510 on a dedicated control connection (not shown) separate from data link 530.

In some embodiments of the invention, packets received from and directed to other computers 110, are handled by chipset 510, e.g., by internal MAC unit 504 thereof. MAC unit 504 optionally performs the tasks required for the reception and transmission, including keeping track of when power lines 112 are busy and when they are idle, generating estimation request packets when necessary and responding to estimation requests from other modems. MAC unit 504 optionally also selects the tone maps to be used in transmitting packets to other computers 110 and acknowledges reception of packets when so required.

Access packets are optionally handled by add-on MAC unit 560, e.g., by access MAC unit 562 thereof. Chipset 510 optionally transfers access packets immediately upon receipt, in order to minimize the delay incurred to the access packets and to allow MAC unit 562 perform its tasks efficiently.

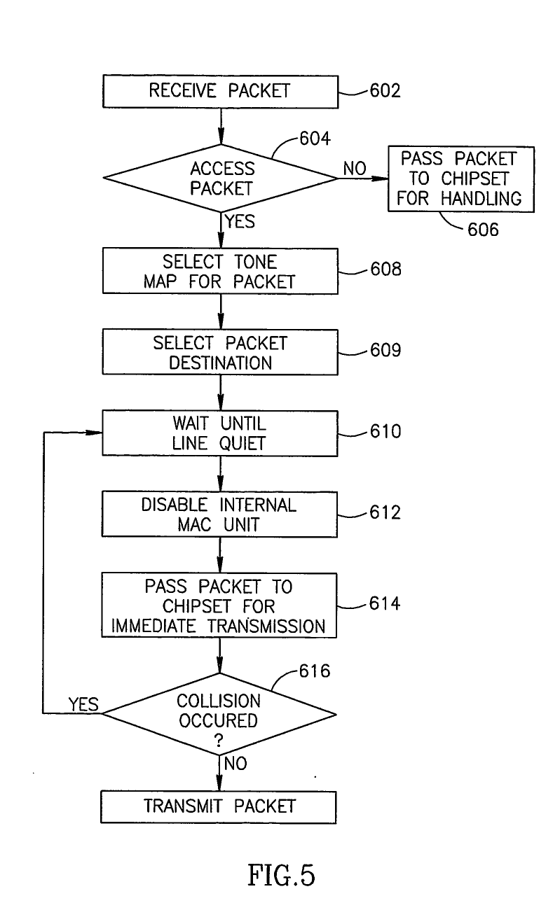

FIG. 5 is a simplified flowchart of acts performed by modem 500 in handling a packet provided by computer 102 for transmission, in accordance with an embodiment of the present invention. When add-on MAC unit 560 receives (602) a packet for transmission, unit 560 optionally determines whether (604) the packet is an access packet. If (604) the packet is not an access packet, the packet is optionally passed (606) through pass-through unit 564 to chipset 510 for handling. For access packets, add-on MAC unit 560 optionally selects (608) a suitable tone map for the transmission, using methods known in the art. If necessary, add-on MAC unit 560 initiates a channel estimation procedure. The channel estimation procedure includes transmitting a channel estimation request. Optionally, the channel estimation request is transmitted in the same manner as data packets received from computer 102 are transmitted. Alternatively or additionally, before transmitting the data packet add-on MAC unit 560 transmits a request-to-send (RTS) packet and waits for a clear-to-send (CTS) packet, as described in the above mentioned PCT publication WO 02/15413. The RTS packet (and the CTS packet) are optionally transmitted using the methods described herein for data packets.

In some embodiments of the invention, add-on MAC unit 560 selects (609) an intermediate destination modem for the packet, if necessary. Optionally, add-on MAC unit 560 manages a routing table which states for each destination address, the next hop to which packets are to be transmitted for that destination. Alternatively or additionally, add-on MAC unit 560 transmits a route determination query packet. Such query packet may be transmitted as part of the RTS or may be transmitted separately. The address in the delimiter of the RTS optionally is the address of the next hop unit. The addresses in the payload of the data packet optionally include both the address of the next hop and of the final destination.

In order to transmit the packet, add-on MAC unit 560 optionally waits (610) until power line 112 is idle. Internal MAC unit 504 is optionally disabled (612) in order to prevent chipset 510 from transmitting an internal MAC packet on power lines 112 when a packet from add-on MAC unit 560 is to be transmitted. By disabling internal MAC unit 504, chipset 510 is kept idle for the packet from add-on MAC unit 560, and the packet can be transmitted substantially immediately onto lines 112. The packet is passed (614) from add-on MAC unit 560 to chipset 510 for transmission on power lines 112.

If (616) while the packet is transferred from MAC unit 560 to chipset 510, on internal data link 530, a packet is received on power lines 112, the packet from add-on MAC unit 560 is optionally discarded. In some embodiments of the invention, chipset 510 notifies add-on MAC unit 560, in a control signal, that the packet was discarded due to a collision. Alternatively, add-on MAC unit 560 determines that the packet was discarded from not receiving an acknowledgment. This alternative minimizes the need for special control signals. Add-on MAC unit 560 optionally waits (610) for a further opportunity in which power lines 112 are idle.

Alternatively to discarding the packet due to receiving a packet on lines 112, chipset 510 stores the packet until the reception of the packet on lines 112 is completed and then transmits the stored packet. In some embodiments of the invention, the storage of the packet by chipset 510 is limited to a predetermined short period, e.g., a few milliseconds. If the reception of the packet from lines 112 is completed within the short period, the stored packet is optionally transmitted on lines 112, otherwise the packet is discarded.

Referring in more detail to waiting (610) until power lines 112 are idle, in some embodiments of the invention, link 530 is associated with a signaling line (e.g., MII_CRS of the MII) which indicates whether line 512 is busy. Optionally, the signaling line carries a busy signal, in addition to when power lines 112 are busy, when a packet from a different modem is expected according to the MAC rules known in the art. In some embodiments of the invention, the signaling line carries a busy signal from the beginning of the transfer of a packet from add-on MAC unit 560 to chipset 510, until the completion of the transmission of the packet on power lines 112. Thus, add-on MAC unit 560 does not attempt to transmit an additional packet before the transmission of the previous packet is completed. Therefore, in some embodiments of the invention, chipset 510 has a single buffer for transmitted access packets.

It is noted that, generally, the transmission time of a packet on power lines 112 is longer than the transfer time on link 530, due to the fact that link 530 generally has a low noise level and is much shorter than power lines 112.

Referring in more detail to disabling (612) internal MAC unit 504, in some embodiments of the invention, the disabling includes preventing the internal MAC unit from transmitting any packets, including data packets, estimation packets, priority symbols and acknowledgment packets. Disabling the transmission of any packets, minimizes the delay in the transmission of signals from add-on MAC unit 560. Optionally, internal MAC unit 504 is not disabled from receiving packets, although acknowledgment packets are not transmitted during the disablement. Alternatively, internal. MAC unit 504 ignores packets received while being disabled. Further alternatively, during disablement, internal MAC unit 504 refrains from transmitting only some packets but transmits other packets. In some embodiments of the invention, internal MAC unit 504 does not transmit data packets, which are generally long, and/or estimation packets, which generally can be deferred, during disablement. On the other hand, acknowledgment packets are optionally transmitted during disablement periods, in order not to disrupt the communication with other modems 106.

Referring in more detail to passing (614) the packet to chipset 510, in some embodiments of the invention, while the packet is being transferred to chipset 510, the chipset examines the header of the packet in order to determine parameters required for the transmission of the packet. Optionally, when the required parameters are found, chipset 510 immediately begins transmitting the packet on power lines 112. In some embodiments of the invention, chipset 510 examines a data block of a predetermined number of bytes (e.g., 32 or 64) before beginning to transmit the packet on power lines 112.

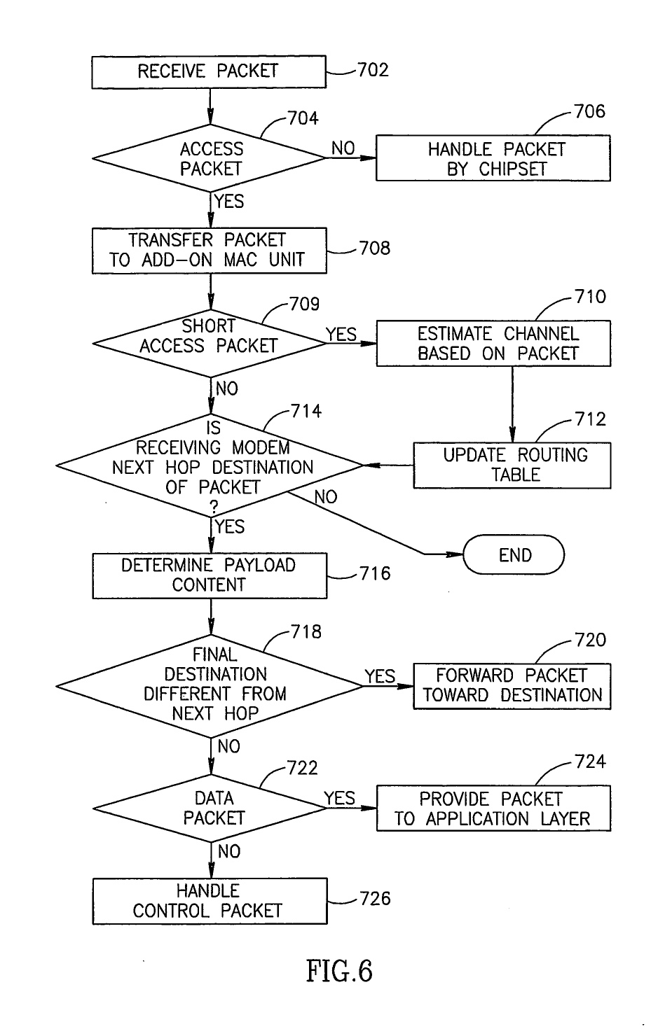

FIG. 6 is a flowchart of acts performed by modem 500 in handling a packet received from power lines 112, in accordance with an embodiment of the present invention. Upon receiving (702) a packet from power lines 112, chipset 510 determines whether (704) the packet is an access packet or an internal packet. If (704) the packet is an internal packet, the received packet is handled (706) by internal MAC unit 504 of chipset 510, as is known in the art. If (704) the received packet is an access packet, the packet is transferred (708) to add-on MAC unit 560, over internal data link 530. Optionally, the packet is transferred along with its delimiter 202 (FIGS. 3A and 3B). Alternatively, the packet is transferred along with the frame control field 214 (FIG. 3A) of the delimiter.

In some embodiments of the invention, the signaling line associated with link 530 is kept busy from the beginning of reception of the packet until the completion of the transfer of the packet to add-on MAC unit 560. It is noted that while the received packet is being transferred on link 530 to add-on MAC unit 560, an additional packet may be received on power lines 112. In such a case, the signaling line will continue to carry a busy signal even after completing the transfer of the packet to add-on MAC unit 560. Chipset 510 optionally includes two buffers for access packets received from power lines 112 for such cases in which a packet is received on lines 112 while a previous packet is being transferred on link 530.

In some embodiments of the invention, an access packet received from power lines 112 is transferred on link 530 immediately after the reception of the packet is completed. Alternatively, while the packet is being received, chipset 510 determines that the packet is an access packet and estimates the time left until the entire packet is to be received. Chipset 510 begins to transfer the packet on link 530 at the earliest time which will allow uninterrupted transfer of the packet on link 530 (i.e., such that the data required for transfer on link 530 will already have been received from lines 512). Optionally, packets shorter than a predetermined length (e.g., short access packets 350), are transferred on link 530 only after they are completely received.

If (709) the packet is a short access packet, the source and destination addresses of the packet are optionally extracted from the delimiter of the packet. The packet is optionally used to estimate (710) the quality of the channel from the source of the packet to the receiving modem. Each modem optionally manages an estimation table, which lists for each other modem the quality of the channel from the other modem to the receiving modem. The entry of the source modem of the received packet is optionally updated according to the estimation (710). Optionally, the update includes using the last determined value. Alternatively, the update includes using the estimation values from a predetermined number of previously received packets from the source and/or using all the packets received from the source within a predetermined amount of time. The estimated values are optionally selected based on a weighted average of the values taken into account.

The estimation values are optionally used in selecting tone maps for transmission of data from the source modem to the receiving modem, using methods known in the art. By using estimation values from a plurality of packets, the estimation better reflects the quality of the channel.

In some embodiments of the invention, chipset 510 manages a routing table that states which units can communicate with each other over power lines 112. Optionally, the source and destination addresses of the received packet are used to update (712) the routing table. Alternatively or additionally, query packets are used to determine the routing tables, periodically and/or when it is desired to transmit a packet to a specific device for which the route is not known or for which the routing data is old.

If (714) the modem receiving the packet is the next hop destination of the packet, the contents of the payload of the packet are determined (716). If (718) the final destination of the packet is different from the next hop address of the packet, the packet is forwarded (720) towards its final destination. In some embodiments of the invention, the routing table is consulted to select a new next hop address for the packet. The packet is optionally prepared again for transmission by the MAC unit and retransmitted on power lines 112 to the next hop. In some embodiments of the invention, the routing table also states the MAC method to be used in transmitting the packet to the next hop. In some of these embodiments, routing information is also collected for the internal MAC method. If (718) the final destination is the same as the next hop address, add-on MAC unit 560 optionally determines (722) whether the packet is a data packet. Data packets are provided (724) to an application layer, while control packets are handled (726) by the MAC unit 560. Exemplary control packets include estimation requests and/or RTS packets.

It is noted that although the above description provides an exemplary embodiment of coexistence of two MAC layer methods, the present invention relates to coexistence of any number of different MAC layer methods.

It is further noted, that the units of the modems described above may be implemented in software, hardware and/or a combination thereof. The modem units described above, are used in the description for clarity and do not necessarily reflect the actual hardware division of the modem. Rather, in some embodiments of the invention, a single hardware unit may be used to implement the physical layer and MAC layer of one or more of the modems and/or a single unit described above may be implemented by a plurality of hardware units. Furthermore, the tasks distribution between the modem units may be different from that described above.

It will be appreciated that the above described methods may be varied in many ways, including, changing the order of steps, and/or performing a plurality of steps concurrently. It should also be appreciated that the above described description of methods and apparatus are to be interpreted as including apparatus for carrying out the methods and methods of using the apparatus.

The present invention has been described using non-limiting detailed descriptions of embodiments thereof that are provided by way of example and are not intended to limit the scope of the invention. It should be understood that features and/or steps described with respect to one embodiment may be used with other embodiments and that not all embodiments of the invention have all of the features and/or steps shown in a particular figure or described with respect to one of the embodiments. Specifically, the methods of FIGS. 5 and 6 are not limited to the embodiment of FIG. 4. Rather, the methods may be used with other embodiments of the invention, such as the embodiment of FIG. 1, with proper adaptations (e.g., the tasks of both chipset 510 and add-on MAC unit 560 are performed by dual MAC unit 172). Variations of embodiments described will occur to persons of the art.

It is noted that some of the above described embodiments may describe the best mode contemplated by the inventors and therefore may include structure, acts or details of structures and acts that may not be essential to the invention and which are described as examples. Structure and acts described herein are replaceable by equivalents which perform the same function, even if the structure or acts are different, as known in the art. Therefore, the scope of the invention is limited only by the limitations used in the claims. When used in the following claims, the terms “comprise”, “include”, “have” and their conjugates mean “including but not limited to”.

1. A modem, comprising:
an application interface for receiving packets to be transmitted on an electrical power network;
a network interface connecting the modem to the electric power network;
at least one media access control (MAC) unit adapted to perform MAC layer tasks in accordance with at least two different MAC protocols, on packets received from the application interface; and
at least one physical layer unit adapted to transmit packets from the at least one MAC unit onto the electric power network, through the network interface, in a same frequency band.

2. A modem according to claim 1, wherein the at least one physical layer unit comprise a single physical layer unit.

3. A modem according to claim 1, wherein the at least one physical layer units comprise a plurality of physical layer units.

4. A modem according to claim 3, wherein the plurality of physical layer units use different modulation methods.

5. A modem according to claim 3, wherein the plurality of physical layer units use different sets of carriers to carry packets.

6. A modem according to claim 3, wherein each of the physical layer units is adapted to transmit packets in accordance with a different respective MAC method.

7. A modem according to any of claims 1-6, wherein the at least one physical layer unit is adapted to transmit each packet at an output power level which depends on the MAC protocol used for transmitting the packet.

8. A modem according to claim 7, wherein the physical layer comprises an analog amplifier adapted to apply different amplification levels to packets transmitted, according to the MAC protocols used for transmitting the packets.

9. A modem according to claim 7, wherein the physical layer is adapted to adjust the power level of digital signals of packets received from the at least one MAC unit, before they are converted into analog signals, according to the MAC protocols used for transmitting the packets.

10. A modem according to any of claims 1-6, wherein the at least one physical layer unit is adapted to transmit packets of the plurality of different MAC protocols in a same frequency band.

11. A modem according to any of claims 1-6, wherein the at least one physical layer unit is adapted to transmit packets of the plurality of different MAC protocols in different respective frequency bands.

12. A modem according to any of claims 1-6, wherein the packets of at least one of the MAC protocols include at least one address field in a header which is understandable by substantially all the devices connected to the network.

13. A modem according to any of claims 1-6, wherein at least one of the MAC protocols allows for retransmission of packets on the same network as on which they were received.

14. A modem according to any of claims 1-6, wherein the plurality of MAC protocols differ in the length of the MAC additions to at least some of the packets they handle.

15. A modem according to any of claims 1-6, wherein the plurality of MAC protocols differ in their ability to use an intermediate modem as a repeater.

16. A modem according to any of claims 1-6, wherein the packets of the plurality of MAC protocols have at least one field having a common format.
